(19) United States
(12) Patent Application Publication
(10) Pub. No.: US 2026/0371382 A1
(43) Pub. Date: Nov. 19, 2026

(54) TRANSMISSION AND RECEIVING DEVICES AND METHODS

(71) Applicant: Sony Group Corporation, Tokyo (JP)

(72) Inventors: Daniel VERENZUELA, Stuttgart (DE); Thomas HANDTE, Stuttgart (DE); Ken TANAKA, Stuttgart (DE); Pukar SHAKYA, Stuttgart (DE)

(73) Assignee: Sony Group Corporation, Tokyo (JP)

(21) Appl. No.: 19/126,667

(22) PCT Filed: Nov. 3, 2023
(86) PCT No.: PCT/EP2023/080661

§ 371 Date: May 2, 2025

(30) Foreign Application Priority Data
Nov. 10, 2022 (EP) 22206682.1

(51) Int. Cl. H04W 74/00; H04L 5/00; H04W 8/22; H04W 74/0816; H04W 80/02

(52) U.S. Cl. CPC H04W 74/002; H04L 5/0053; H04W 8/22; H04W 74/0816; H04W 80/02

(57) ABSTRACT

Transmission device comprising circuitry configured to obtain and/or generate input data units comprising MAC service data units (MSDUs) and/or control data units to be transmitted to receiving devices, generate MAC protocol data units (MPDUs) from said input data units by adding header information which includes the receiver address of one or more input data units; generate aggregated MAC protocol data units (A-MPDUs) from said MPDUs, wherein an A-MPDU is generated from at least two of said MPDUs and wherein into at least one A-MPDU MPDUs addressed to different receiving devices identified by the receiver address in the header of each MPDU are included; generate physical layer protocol data units (PPDUs) from said A-MPDUs; provide in said PPDUs and/or said A-MPDUs a multi-receiver indication implicitly or explicitly indicating if an A-MPDU includes MPDUs addressed to different receiving devices; and transmit PPDUs containing at least one A-MPDU transmitted to different receiving devices.

### BACKGROUND

### Field of the Disclosure

The present disclosure relates to a transmission device, a receiving device, a transmission method and a receiving method.

### Description of Related Art

Growing latency sensitive applications like extended reality (XR) gamming, remote surgery and smart manufacturing require the delivery of data units (herein also called latency sensitive data units or preemptive data units) within a few milliseconds or less. In conventional WLAN operation, Medium Access Control (MAC) Protocol Data Units (MPDUs) are included by a transmission device (e.g. a transmitter station (STA) or an access point (AP)) in an aggregated MPDU (A-MPDU). All MPDUs within an A-MPDU are addressed to the same receiving device (e.g. a receiver STA). On a Physical (PHY) layer the A-MPDUs are embedded into PHY protocol data unit (PPDUs), which are then transmitted from the transmission device to the receiving device.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to provide for more flexibility regarding the transmission of latency sensitive data units and/or to enable a faster delivery of such latency sensitive data units. It is a further object to provide transmission and reception device as well as a corresponding computer program and a non-transitory computer-readable recording medium for implementing said methods.

According to an aspect there is provided a transmission device comprising circuitry configured to:
obtain and/or generate input data units to be transmitted to one or more receiving devices, said input data units comprising MAC service data units (MSDUs) and/or control data units;
generate MAC protocol data units (MPDUs) from said input data units by adding header information to one or more of said input data units, the header information including at least the receiver address of said one or more input data units;
generate one or more aggregated MAC protocol data units (A-MPDUs) from said MPDUs, wherein an A-MPDU is generated from at least two of said MPDUs and wherein into at least one A-MPDU MPDUs addressed to different receiving devices identified by the receiver address in the header of each MPDU are included;
generate physical layer protocol data units (PPDUs) from said A-MPDUs;
provide in said PPDUs and/or said A-MPDUs a multi-receiver indication implicitly or explicitly indicating if an A-MPDU includes MPDUs addressed to different receiving devices; and
transmit said PPDUs, wherein the PPDU containing said at least one A-MPDU is transmitted to different receiving devices.

According to a further aspect there is provided a reception device comprising circuitry configured to:
receive physical layer protocol data units (PPDUs) from a transmission device;
derive, from a received PPDU or an aggregated MAC protocol data unit (A-MPDU) included in a received PPDU, a multi-receiver indication explicitly or implicitly indicating if an A-MPDU included in the received PPDU includes MAC protocol data units (MPDUs) addressed to different receiving devices; and
de-aggregate at least one A-MPDU for which a multi-receiver indication indicates that it includes MPDUs addressed to different receiving devices and to extract a receiver address from a header of the MPDUs; and
obtain one or more input data units from MPDUs addressed to the receiving device based on said receiver address, said input data units comprising MAC service data units (MSDUs) and/or control data units.

According to still further aspects a computer program comprising program means for causing a computer to carry out the steps of the method disclosed herein, when said computer program is carried out on a computer, as well as a non-transitory computer-readable recording medium that stores therein a computer program product, which, when executed by a processor, causes the method disclosed herein to be performed are provided.

Embodiments are defined in the dependent claims. It shall be understood that the disclosed methods, the disclosed computer program and the disclosed computer-readable recording medium have similar and/or identical further embodiments as the claimed devices and as defined in the dependent claims and/or disclosed herein.

One of the aspects of the disclosure is to change the MAC operation of WLAN to support the transmission of A-MPDUs containing MPDUs that are addressed to different receiving devices (herein also referred to as multi-STA A-MPDUs). This change allows the insertion of latency sensitive/preemptive MPDUs in an ongoing transmission of a PPDU carrying an A-MPDU.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1A shows a schematic diagram of MAC and PHY operation according to conventional WLAN operation for transmitting MSDUs.

FIG. 1B shows a schematic diagram of MAC and PHY operation according to conventional WLAN operation for transmitting input data units including MSDUs and/control data units.

FIG. 2 shows a schematic diagram of conventional MAC operation illustrating the problem dealt with by the present disclosure.

FIG. 3 shows a schematic diagram of an A-MPDU as used according to the present disclosure.

FIG. 4 shows a schematic diagram of MAC and PHY operation according to an embodiment of the present disclosure.

FIG. 5 shows a diagram of the main MAC processing blocks in the MAC plane architecture for a WLAN STA according to an embodiment of the present disclosure.

FIG. 6 shows a schematic diagram illustrating an embodiment of the general transmitter STA operation according to the present disclosure.

FIG. 7 illustrates the construction of a PPDU and a TXOP according to an embodiment of the present disclosure.

FIG. 8 shows a schematic diagram illustrating a first embodiment of an acknowledgement policy according to the present disclosure.

FIG. 9 shows a schematic diagram illustrating a second embodiment of an acknowledgement policy according to the present disclosure.

FIG. 10 shows a schematic diagram illustrating a third embodiment of an acknowledgement policy according to the present disclosure.

FIG. 11 shows a schematic diagram illustrating a fourth embodiment of an acknowledgement policy according to the present disclosure.

FIG. 12 shows a schematic diagram illustrating a fifth embodiment of an acknowledgement policy according to the present disclosure.

FIG. 13 shows a schematic diagram of another embodiment of the present disclosure relating to the insertion of a high priority MPDU in an A-MPDU after PPDUTXSTART.request.

FIG. 14 shows a schematic diagram of an embodiment of insertion of a preemptive MPDU in a multi-STA A-MPDU according to the present disclosure using fragmentation.

FIG. 15 shows schematic diagrams of embodiments of insertion of a preemptive MPDU in a multi-STA A-MPDU according to the present disclosure using padding and/or MSDU aggregation.

FIG. 16 shows a flowchart of an embodiment of a transmission method according to the present disclosure.

FIG. 17 shows a flowchart of an embodiment of a receiving method according to the present disclosure.

### DETAILED DESCRIPTION OF THE EMBODIMENTS

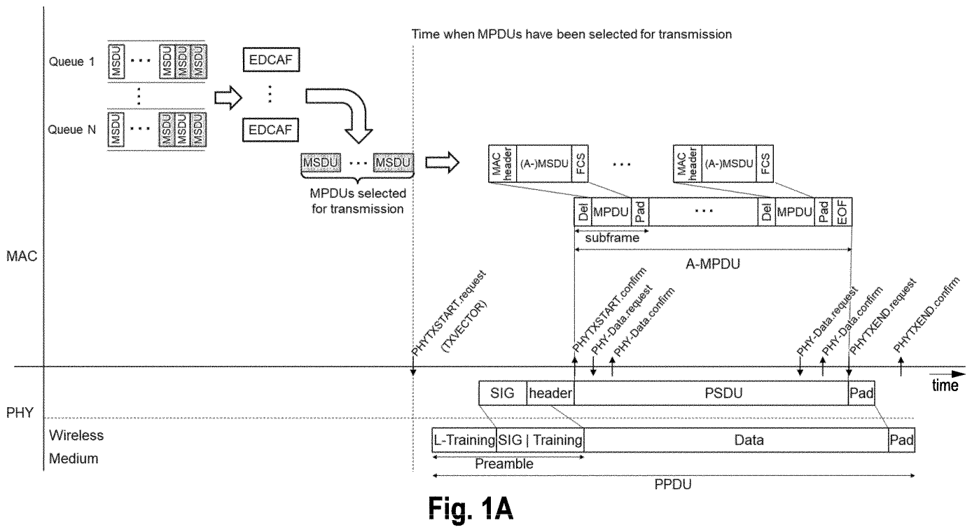

Referring now to the drawings, wherein like reference numerals designate identical or corresponding parts throughout the several views, FIGS. 1A and 1B show schematic diagrams of MAC and PHY operation according to conventional WLAN operation. In WLAN, the Medium Access Control (MAC) layer starts the transmission of MAC protocol data units (MPDUs) by sending a PHYTXSTART.request indication to the Physical (PHY) layer as shown in FIGS. 1A and 1B. This indication contains the parameter list called TXVECTOR which is used to configure the PHY operation.

The MPDUs contain one or more MAC service data units (MSDUs) (as shown in FIG. 1A) and/or control data units (as shown in FIG. 1B). The MSDUs arrive from higher layers and are placed in different queues at the MAC layer depending on their priority. Enhanced distributed channel access functions (EDCAFs) coordinate the channel access for transmitting MSDUs from the queues. A single MSDU can be transmitted at a time or multiple MSDUs can be aggregated to form an Aggregated MSDU (A-MSDU). To transmit the MSDUs as shown in FIG. 1A or the input data units as shown in FIG. 1B the MAC layer creates MPDUs by taking the MSDUs and adding a MAC header and a frame check sequence (FCS). The MAC header contains signaling information that includes transmitter address and receiver address (RA), duration, frame control, etc., and the FCS corresponds to a sequence used to validate if the MPDU is received correctly at the receiver.

An A-MPDU comprises a concatenation of MPDUs which are encapsulated in subframes, each subframe having a delimiter (DEL) and an optional padding (PAD) field. The DEL contains the length of the MPDU in a subframe and a signature to help identify each subframe at the receiver while the PAD is used to make sure the length of each subframe is a multiple of a set number of bits, e.g. 32 bits. It should be noted that a subframe can be comprised of only a DEL field with length zero, which in turn can be used to meet the minimum MPDU start spacing requirement or for additional padding. At the time the PHYTXSTART.request indication is sent, the MSDUs scheduled for transmission have al-ready been selected and the total data length (in octets) is indicated via the TXVECTOR. The A-MPDU is carried by a PHY layer as a PHY service data unit (PSDU). The PSDU is processed by the PHY and transmitted into the wireless medium as a PHY protocol data unit (PPDU). The PPDU contains a preamble, including training and signaling fields, and a data field where the PSDU is carried.

Once the PHYTXSTART.request is received by the PHY, the process to transmit a PPDU starts with the PHY preamble. The PHY sends a PHYTXSTART.confirm indication to the MAC to indicate that it is ready to receive data. Afterwards, the MAC issues a PHY-Data.request indication to transfer an octet of data to the PHY, which in turn transmits the octet. Once the PHY receives the data octet it issues a PHY-Data.confirm to indicate to the MAC that it is ready to receive another octet. This process is done continuously until the last octet of the PSDU is sent. Finally, the MAC issues a PHYTXEND.request to indicate to the PHY that the PSDU transmission is completed and in turn the PHY finishes the PPDU transmission and issues a PHYTXEND.confirm to the MAC.

In WLAN operation, all the MPDUs included in an A-MPDU are addressed to the same receiver (herein also called receiving device or receiver STA). This limits the flexibility the transmitter (herein also called transmission device or transmitter STA) has to deliver data to different STAs (i.e., different receiving devices) with different levels of priority.

For an A-MPDU transmission, the MPDUs are often selected once the MAC sends PHYTXSTART.request to PHY. If a high priority MPDU, addressed to a different STA than that of the initial A-MPDU, is queued after the PHYTXSTART.request but before the last scheduled MPDU has been sent, it cannot be sent according to the conventional WLAN operation.

It shall be noted in this context that MPDUs can generally carry MSDUs and/or control data units, commonly also referred to as input data units herein (see FIG. 1B). Control data units shall herein be understood as control and/or management frames like acknowledgements, link measurements, triggers, channel reservation indications (RTS/CTS), association, authentication, beacons, etc. According to the present disclosure, input data units (MSDUs and/or control data units) to be transmitted to one or more receiving devices are obtained or generated by the transmission device. MPDUs are then generated from said input data units by adding header information to one or more of said input data units, which are then aggregated into A-MPDUs. The MAC header for the MSDUs may be different from the MAC header for control data units, but generally there is transmitter and receiver address information in the MAC header. The differences may mainly relate to additional information for the receivers to know how to interpret specific parts of the control data unit.

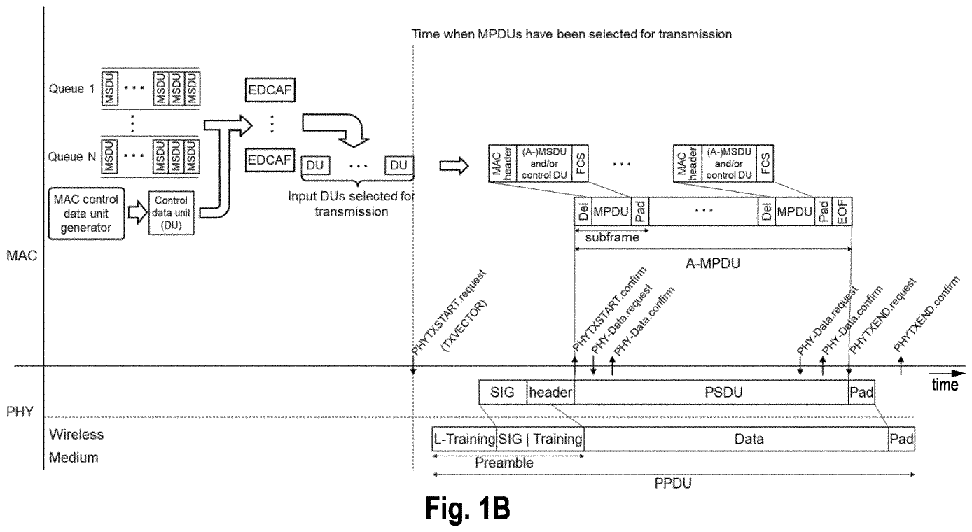

FIG. 2 shows a schematic diagram of conventional MAC operation illustrating the problem dealt with by the present disclosure, in particular the delay of high priority data transmission up to the next PPDU. At the time the PHYTXSTART.request is issued by the MAC, the receiver STA 1 for the A-MPDU has been selected. Afterwards, during the transmission of the PPDU carrying said A-MPDU, a high priority MSDU addressed to receiver STA 2 is queued. Since the current transmission of the A-MPDU cannot contain MPDUs addressed to different individual STAs other than STA 1 and the PPDU transmission cannot be stopped, the transmission of the high priority MSDU for STA 2 needs to be delayed until the next PPDU transmission. This delay may be too high for latency sensitive applications.

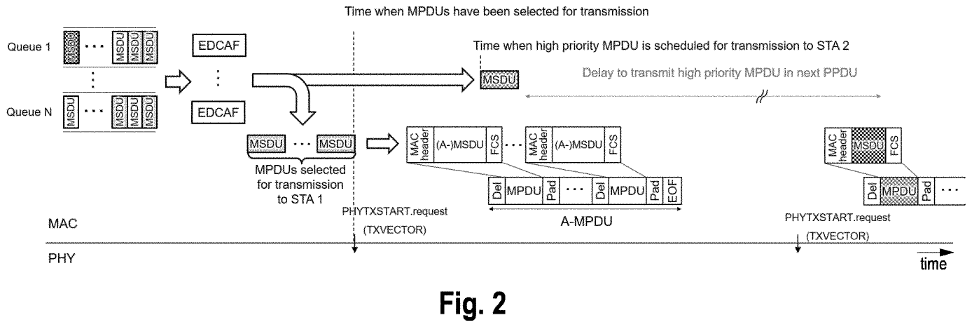

According to the present disclosure modifications to the MAC operation are made to support the insertion of MPDUs addressed to different receiver STAs within an A-MPDU. FIG. 3 shows a schematic diagram of an A-MPDU 10 as used according to the present disclosure. Herein, this A-MPDU 10 containing the insertion of MPDUs 11, 12 to different receiver STAs (i.e., MPDU 11 is addressed to a different receiver STA than MPDU 12) is called Multi-STA A-MPDU. One of the modifications to the frame structure of the A-MPDU is to allow a different receiver address (RA) in the MAC header of MPDUs carried in A-MPDU subframes of the same A-MPDU.

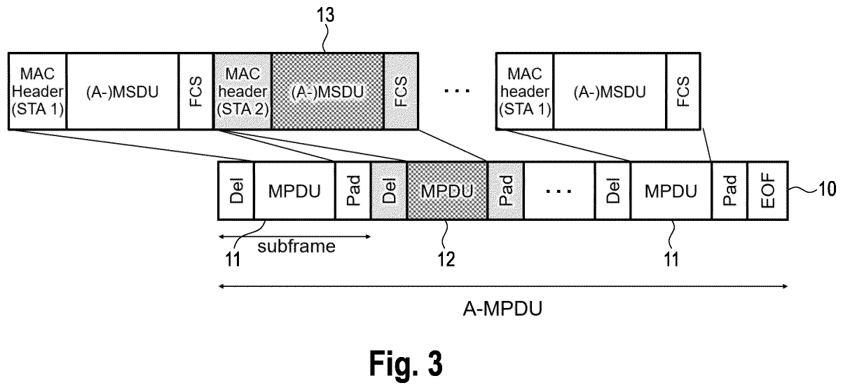

This feature can be implemented to allow one or more high priority MSDUs 13 destined to different STAs, to be carried in the same A-MPDU. Moreover, in the context of preemption, it enables high priority MSDUs to be transmitted in an ongoing PPDU transmission (after the PHYTXSTART.request) if its transmission time allows it. This is illustrated in FIG. 4 showing a schematic diagram of MAC and PHY operation according to an embodiment of the present disclosure enabling the insertion of a preemptive MPDU in an A-MPDU 10 during an ongoing transmission of a PPDU. This feature allows timely delivery of latency sensitive data which otherwise would need to wait for another PPDU transmission as shown in FIG. 2.

To support the use of Multi-STA A-MPDUs, a session setup may be implemented between the transmitter and potential receiver STAs. The session setup creates an agreement on the mode of operation defined by one of the following:
a) Case 1, fixed receiver STA agreement: Define at least a primary receiver STA and a one or more secondary receiver STAs, identified by the MAC address and/or the Association Identifier (AID). The primary STA is the main target receiver of a Multi-STA A-MPDU where the first MPDU in the multi-STA A-MPDU is addressed to it. In addition, the initial frame exchange to establish a transmit opportunity (TXOP) may only be done with the primary STA. The secondary receiver STA may receive one or more MPDUs addressed to it in a multi-STA A-MPDU which has its first MPDU addressed to the primary STA.
b) Case 2, dynamic receiver STA agreement: Define a set of potential receiver STAs that can support Multi-STA A-MPDU operation, each STA is identified by the MAC address and/or AID. Out of this set, a primary receiver STA is selected when establishing a TXOP. The main roles of the primary and secondary STAs are the same as in case 1.

The multi-STA A-MPDU session setup may additionally be used to exchange capabilities between transmitter and potential receiver STAs, defined parameters, indications and specific features to be used. The information exchanged in a session setup contains one or more of the following:
Session identifier;
Type of indication to identify a Multi-STA A-MPDU;
PPDU type that can carry a multi-STA A-MPDU;
Time interval during which multi-STA A-MPDUs can be transmitted, including start time, duration and/or end time;
Traffic identifier (TID) and/or access categories (AC) that can be used to identify the priority of a multi-STA A-MPDU;
Minimum MPDU start spacing for multi-STA A-MPDUs that can be supported by all STAS;
PHY parameters (e.g., bandwidth, NSS, MCS, RU size, guard interval) that are supported by all STAs addressed in Multi-STA A-MPDU session;
Acknowledgement policy that can be used for multi-STA A-MPDUs; and
Resource unit (RU) pre-allocation that shall be used to transmit Multi-STA A-MPDUs that are carried by multi-user (MU) PPDUs.

In the following, details of the multi-STA A-MPDU operation as disclosed herein will be described in more detail. All STAs that are the intended receivers of at least one MPDU within a multi-STA A-MPDU must be able to decode the PPDU carrying said multi-STA A-MPDU. Thus, the following considerations may be taken into account.

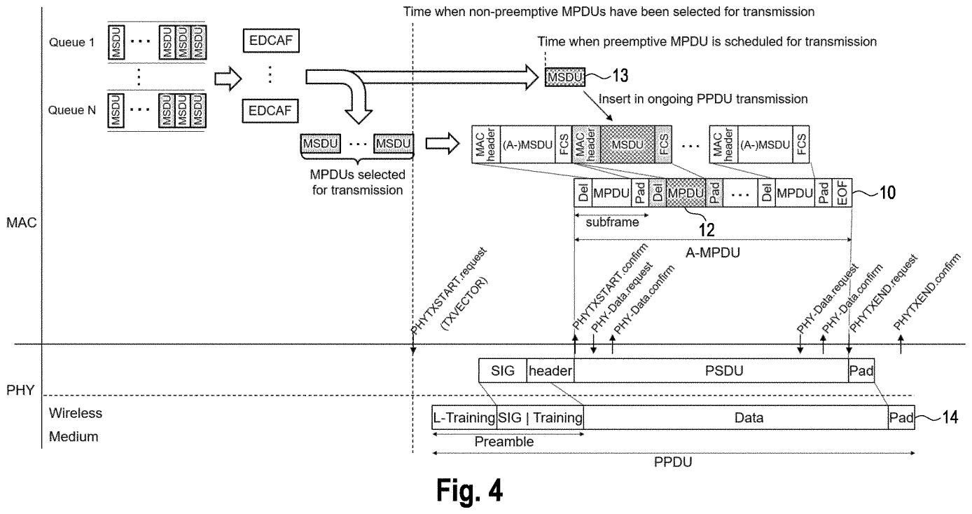

FIG. 5 shows a diagram of the main MAC processing blocks in the MAC plane architecture for a WLAN STA according to an embodiment of the present disclosure. The flow of data units when a transmitter STA is transmitting MSDUs is shown in the left column (MSDU flow—Transmitting 20) and the flow of data units when a receiver STA is receiving MSDUs is shown in the right column (MSDU flow—Receiving 30). In the transmitter flow the MSDUs are obtained from higher layers, optionally aggregated (step 21) or fragmented (step 22) depending on their size to increase the efficiency of data transmission. Then, the MSDUs are encrypted (step 23) to add security in their transmission. The MPDUs are created by inserting the MPDU header (also called MAC header) and appending a cyclic re-dundancy check (CRC) bits (step 24). Finally, the MPDUs are aggregated (step 25) and send to the PHY layer for transmission. In the receiver flow the A-MPDUs or MPDUs are received from PHY layer, de-aggregation (step 31) of an A-MPDU (if present) is performed to obtain individual MPDUs. For each MPDU the header information is extracted and the CRC validation (step 32) is performed to check if the MPDU was received correctly. The receiver address (RA) filtering (step 33) checks that the RA in the header information matches with the RA of the receiver device, if the addresses match the receiver device continues processing the MSDU content. This involves Block Ack scoreboarding (step 34) to keep track of received MSDUs, and duplicate detection (step 35) to identify MSDUs that have been received more than once. Then the MSDUs are decrypted (step 36), defragmented (step 37) and de-aggregated (step 38) (if the MPDU contains an A-MSDU). Finally, the MSDUs are forwarded to higher layers.

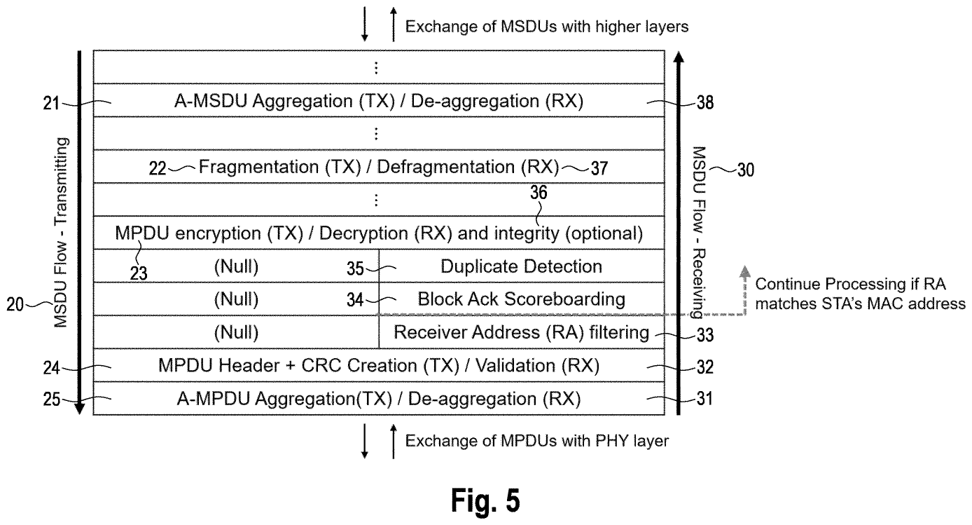

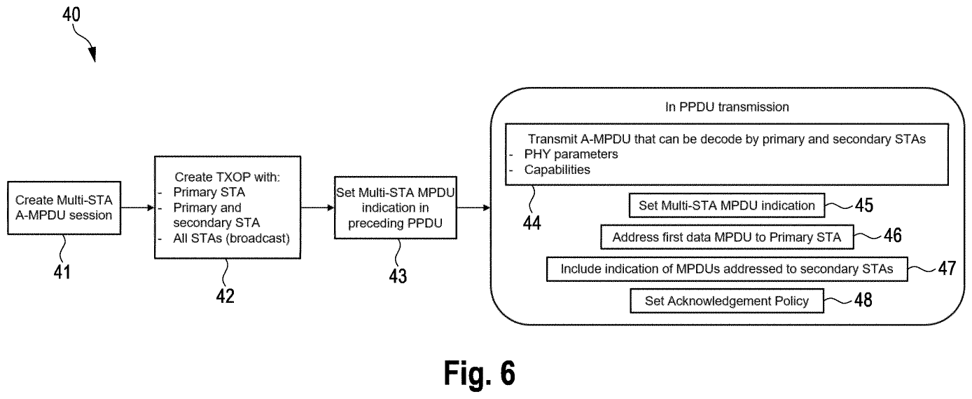

FIG. 6 shows a schematic diagram illustrating an embodiment of the general transmitter STA operation 40 according to the present disclosure. FIG. 7 illustrates the corresponding construction of a PPDU 14 and a TXOP according to an embodiment of the present disclosure. Initially, a multi-STA A-MPDU session setup with potential receiver STAs is made (step 41) and a TXOP is created (step 42) with the primary STA, or the primary and secondary STAs, or all STAs (broadcast). A multi-STA A-MPDU should not be made with a receiver STA, which is not part of a previous agreement done in multi-STA A-MPDU session.

A multi-STA A-MPDU indication 15 (also called multi-receiver indication) may be set and used (steps 43 and 45) to indicate that the current and/or next PPDU contains a multi-STA A-MPDU. This multi-STA A-MPDU indication can be done in a separate PPDU before the PPDU containing the multi-STA A-MPDU (step 43), or it can be done within the PPDU containing the multi-STA A-MPDU (step 45). Further, this indication can be done implicitly or explicitly. An implicit indication may be given by the type of PPDU and/or a time interval during which the PPDU is transmitted and/or an A-MPDU that has the first MPDU MAC address set to the primary STA. The implicit indication should be fixed within a multi-STA A-MPDU session setup.

On the MAC level, an explicit indication may be given in the MAC header identifying the current frame as a multi-STA A-MPDU frame. This indication can be carried in the frame control field. Another explicitly indication may be given in the DEL at the start of the A-MPDU and/or in the first A-MPDU subframe addressed to the primary STA to identify the A-MPDU as a multi-STA A-MPDU. This may be done by using a special DEL signature. Another explicit indication may be given on by a PHY level Indication in the PHY preamble of the PPDU to indicate the presence of a multi-STA A-MPDU, in particular as indication of which RU contains a multi-STA A-MPDU. As still another option, an explicit indication may be given in a separate frame, which can be a dedicated frame or an information field part of a frame that its directly (e.g. after regulatory interframe space (IFS)) followed by a PPDU containing a multi-STA A-MPDU. This frame may indicate the same information as mentioned above for the other options of multi-STA A-MPDU indication.

Subsequently, as the first MPDU containing data, an MPDU 11 addressed to the primary receiver STA is included (step 46). The RA in the MAC header of each MPDU is set to the MAC addresses of the STA to which the MPDU is addressed. Further, the AID is set to the primary STA's AID if the PPDU format requires this information (e.g., includes a user info field as part of a MU-PPDU).

An indication 16 (called secondary STA MPDU indication or simply secondary MPDU indication) of MPDUs addressed to a secondary receiver STAs, if present, will be included (step 47), which can be done by one or more of the following:
Provide a session identifier, which can be added in the PHY or MAC signaling;
Include in the MAC signaling at the start of the A-MPDU a tuple with the secondary STA's MAC address and MPDU location within the A-MPDU of the MPDUs addressed to it;
Use a special DEL preceding and/or in an A-MPDU subframe containing an MPDU addressed to a secondary STA, which can be done by using a special DEL signature; and
Include in the PHY signaling the AID of the secondary STAs, or a group AID to identify primary and/or secondary STAs, that are addressed in a multi-STA A-MPDU that is transmitted in the corresponding RU, which can be added as part of the user info field.

Preferably, it shall be ensured that the PHY parameters (e.g., MCS, NSS, bandwidth, RU size, guard interval) used to configure the transmission of a PPDU that may carry a multi-STA A-MPDU are supported by all receiver STAs and that all capabilities of each potential receiver STAs that may be addressed in a multi-STA A-MPDU are met (e.g., minimum MPDU start spacing). Further, it shall preferably be ensured that the TIDs of the MPDUs carried by a multi-STA A-MPDU belong to an AC that has the same or higher priority than the primary AC. The primary AC corresponds to the Enhanced Distributed Channel Access Function (EDCAF) that gained channel access.

A multi-STA A-MPDU may then be transmitted (step 44) within a TXOP for which the TXOP responder is set to the primary STA, or the primary and secondary STAs or all STAs (broadcast). In an embodiment an acknowledgement policy is set (step 48) to support one of the following (the acknowledgement operation will be described below): Immediate response for a single receiver STA, immediate response for at least two receiver STAs, or delayed or no response for all receiver STAs, where the acknowledgement policy is set to no response (No Ack) or delayed response Block Ack (BA).

The general primary STA (primary receiver) operation may, in an embodiment, be as follows. The primary STA listens to any A-MPDU that is addressed to itself, which is identified by AID and/or MAC address. It listens to a TXOP and/or participates in a TXOP establishment for which the TXOP responder is set to itself or broadcast. An MPDU is retrieved in an RU addressed to the AID and/or in an RU that matches its own AID, or an MPDU addressed to a MAC address that matches its own is retrieved. Then, it participates in a multi-STA A-MPDU session setup and identifies itself as the primary receiver STA based on the agreed mode of operation. It should be noted in this context that the order of the steps may be different as well. For instance, another (not limiting order might be: 1) participate in multi-STA session setup; 2) participate in TXOP creation; 3) listen to A-MPDUs addressed to itself or broadcast; 4) retrieve MPDU addressed to itself.

The RA in the MAC header of a received MPDU that is part of an A-MPDU may be evaluated as follows: If the RA corresponds to its own MAC address, processing the MPDU is continued as shown in FIG. 5 after step 33, i.e., MSDU content is extracted, decrypted and forwarded to higher layers. If the RA does not correspond to its own MAC address, the MPDU content is discarded, and it is advanced to the next MPDU. The advance operation is defined by the MPDU length information found in the DEL. Finally, an acknowledgment policy set to the received MPDUs is followed.

The general secondary STA (secondary receiver) operation may, in an embodiment, be as follows. The secondary STA listens to any A-MPDU that is addressed to itself or all STAs, or to the primary receiver STA, which is identified by AID and/or MAC address set to the secondary STA, broadcast, or primary STA, respectively. It listens to a TXOP and/or participates in a TXOP establishment for which the TXOP responder is set to itself and the primary STA or broadcast, or to the primary STA. An MPDU in an RU addressed to the AID that matches its own and/or of the primary STA, or an MPDU addressed to the MAC address that matches its own and/or of the primary STA is retrieved. Further, it participates in a multi-STA A-MPDU session setup and identifies itself as a secondary receiver STA based on the agreed mode of operation. As mentioned above, the order of the steps may be different and is not limited to the order in which the steps are described here.

The secondary STA listens to any A-MPDU that is identified as a multi-STA A-MPDU provided by the transmitter STA. The RA in the MAC header of a received MPDU that is part of an A-MPDU may be evaluated as follows: If the RA corresponds to its own MAC address, processing the MPDU as shown in FIG. 5 is continued, i.e., MSDU content is extracted and decrypted. If the RA does not correspond to its own MAC address, the MPDU content is discarded, and it is advanced to the next MPDU. An advance operation is defined by the MPDU length information found in the DEL. Finally, an acknowledgment policy may be set to the received MPDUs.

It shall be noted that an essential element of the present disclosure is that MPDUs in an A-MPDU can be addressed to different receivers. However, not in all A-MPDUs MPDUs addressed to different receivers need to be added, but in some A-MPDUs all MPDUs may be addressed to the same receiver. This may e.g. be the case if, e.g., in a preemption case there is not enough time available in the PPDU to add an MPDU addressed to a different receiver. Thus, the multi-STA A-MPDU indication may always be there explicitly or implicitly, but the actual MPDU that has a different receiver address may or may not be included in an A-MPDU.

In the following multi-STA acknowledgement operation will be described. The acknowledgement procedure, where the receiver indicates to the transmitter the correct or incorrect reception of received data units, is a fundamental aspect of WLAN networks to provide quality of service. In WLAN an acknowledgment can be provided for each MPDU being transmitted. In a multi-STA A-MPDU, at least two MPDUs are directed to different STAs. Thus, the acknowledgement operation is coordinated according to an embodiment for all STAs that are receivers of a multi-STA A-MPDU.

There are at least four main acknowledgement policies (Ack policies) that can be extended to support multi-STA A-MPDU acknowledgements.
1) No Ack: This means that the receiver STA will not take any acknowledgement related action when receiving the MPDU and the transmitter STA discards the MPDU as soon as it is transmitted
2) Normal Ack: simple acknowledgement frame that is transmitted by the receiver STA a predetermined IFS after the PPDU carrying the MPDU is received. This policy does not support A-MPDU acknowledgment since the Ack can only provide feedback for the reception of one MPDU.
3) Implicit Block Ack Request (BAR): The receiver STA can send acknowledgments for one or more MPDUs within a Block Ack (BA) frame that can be sent individually or as part of an A-MPDU that is transmitter a predetermined IFS after the reception of the PPDU carrying the MPDUs needing to be acknowledged. This policy sup-ports A-MPDU acknowledgement.
4) BA: The receiver STA does not take an immediate action when receiving MPDUs except to update the scoreboard, i.e., record the state of acknowledgements. The receiver STA sends BA after receiving a BAR from the transmitter STA at a future point in time.

The Ack policies can be standardized or pre-agreed as part of the multi-STA A-MPDU session setup, such that only a simple indication to identify the Ack policy can be included in the MPDUs. Alternatively, the indication can be implicitly obtained from the <TID, RA> tuple. The acknowledgement procedure for multi-STA A-MPDUs may be based on the number of receivers requiring (or not) an immediate response. The different Ack policies will now be explained.

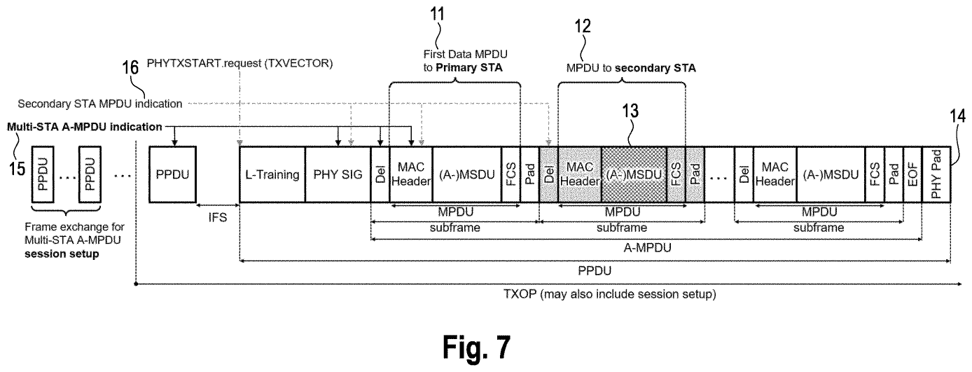

FIG. 8 shows a schematic diagram illustrating a first embodiment (case 1) of an Ack policy according to the present disclosure. According to this embodiment only MPDUs to one receiver STA (e.g. STA 2, representing a secondary receiver) require an immediate response, in particular need to be acknowledged immediately after being received. Thus, STA 2 must use either normal Ack or implicit BAR policy whereas other receiver STAS, e.g., STA 1 (representing primary receiver), must use BA or No Ack policy. This case can be relevant when STA 2 receives high priority traffic and STA 1 low priority traffic, such that the acknowledgement from STA 2 is time critical but the one from STA 1 can be sent at a later point in time.

In the case all MPDUs addressed to STA 2 have the same Ack state (successfully de-coded or not), a normal Ack policy can be used to send a compressed BAck. Here, it is necessary to also add an indication to identify this frame as a compressed BAck that co-vers all acknowledgements to MPDUs that were transmitted in the immediately preceding PPDU. In case multiple multi-STA A-MPDUs are transmitted within a MU-PPDU, only the MPDUs addressed to one STA in one multi-STA A-MPDU may respond with an immediate acknowledgement.

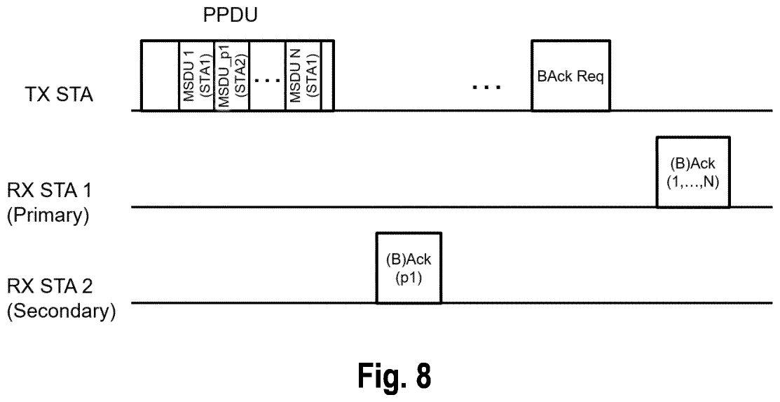

According to further embodiments MPDUs of at least two receiver STAs require an immediate response. This case can be further described based on whether the transmitter sup-ports TF or not (i.e., STA is an AP or not). FIG. 9 shows a schematic diagram illustrating a second embodiment (case 2a) of an Ack policy according to the present disclosure. According to this embodiment trigger-based operation is performed where the transmitter is an AP. All the MPDUs in the multi-STA A-MPDU that require a response must utilize BA policy, MPDUs with no Ack policy can also be included. The AP sends a trigger frame (TF) immediately (after an IFS) after the PPDU carrying the multi-STA A-MPDU is sent. The TF carries a BA request to which the STAs respond with the corresponding acknowledgement and optionally with data units to the AP within a trigger based PPDU (TB-PPDU). As illustrated in FIG. 9 the MPDUs sent to STA 2 and STA 3 require an immediate response, which is sent in the TB-PPDU after the TF sent by the AP. The TB-PPDU in FIG. 9 contains two RUs, one for STA 2 (upper part) and one for STA 3 (bottom part).

If the PPDU carrying the multi-STA A-MPDU contains other MPDUs that do not require an immediate response, a BA can be sent in the same TB-PPDU (different RU) or after the AP sends a BAR at a later point in time (as shown in FIG. 9). According to a variant, the AP includes a triggered response scheduling (TRS) field in the PPDU containing the multi-STA A-MPDU where the BA requests are added. The receiver STAs would reply (after an IFS) within a TB-PPDU as shown in FIG. 9.

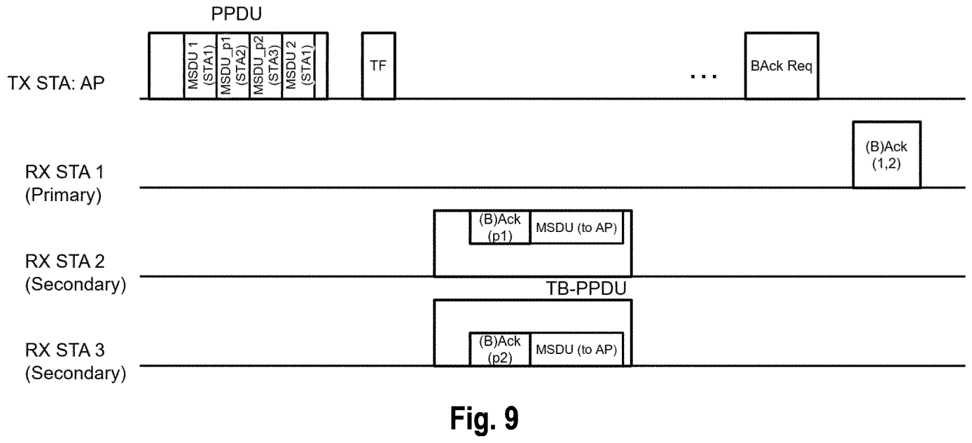

According to further embodiments non-trigger-based operation is performed, according to which the transmitter STA can be a non-AP. These cases (case 2b) focus on non-trigger-based operation since a non-AP STA cannot send a TF, however, the operation herein can also be done by the AP. A first approach is illustrated in FIG. 10 showing a schematic diagram illustrating a third embodiment of an Ack policy according to the present disclosure, according to which the transmitter STA sets all MPDUs requiring a response to BA policy and then sends BARs sequentially to the receiver STAs who's MPDUs require an immediate response. The order in which the BARs are sent can be chosen based on TIDs. If there are other MPDUs requiring a non-immediate response, the transmitter STA can send a BAR at a later point in time.

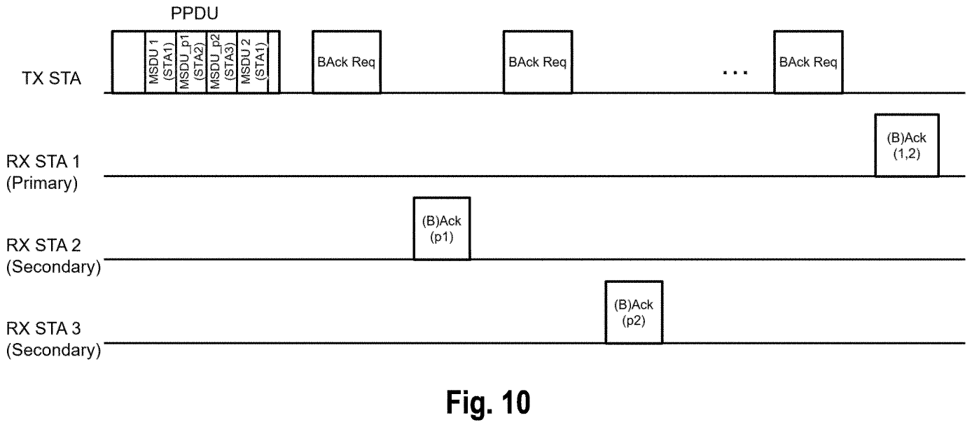

A second approach is illustrated in FIG. 11 showing a schematic diagram illustrating a fourth embodiment of an Ack policy according to the present disclosure, according to which the implicit BAR policy is used for MPDUs requiring an immediate response with an additional indication, shown as sequential BAR (SBAR) in FIG. 11 that indicates to each receiver STA the order in which the acknowledgements will be sent. The receiver STAs will then send BAck frames sequentially a predetermined IFS after the PPDU carrying the multi-STA A-MPDU has finished. The other MPDUs must be set to BA or no Ack policy. In case some MPDUs require a non-immediate response, the transmitter STA can send a BAR at a later point in time.

In the aforementioned approaches utilizing either BAR or SBAR, non-immediate BAck can be included in immediate BAck frames if the receiver STA is the same. In the SBAR approach, if several receiver STAs send their BAck sequentially, it is preferred to maintain their BAck transmissions aligned in time to avoid collisions and/or preserve the regulatory IFS. According to FIG. 11 it is assumed that STA 2 and STA 3 are in range of each other, and STA 3 can detect when the BAck (p1) transmission ends, such that it can send its corresponding BAck (p2) frame right after a predetermined IFS.

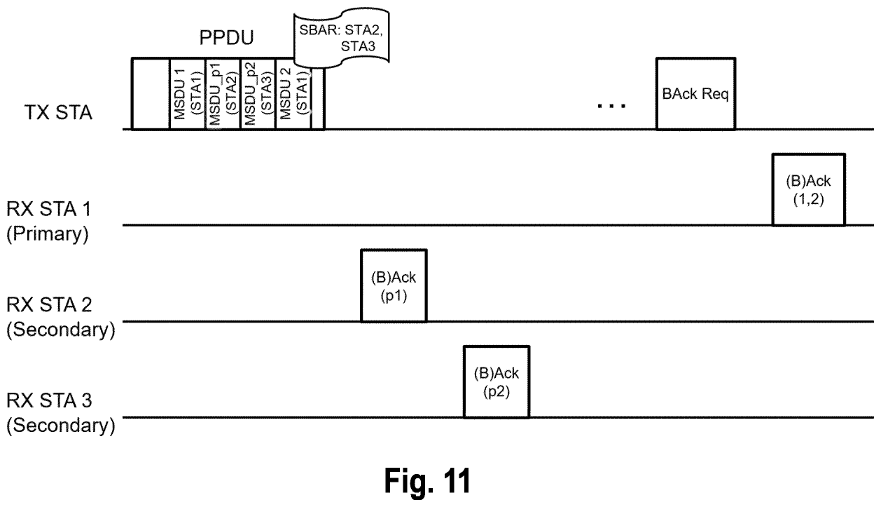

In case STA 2 and STA 3 are out of range from each other, the transmitter STA can send a short Ack frame after each BAck frame from each receiver STA (except the last one), to preserve the time alignment among BAck transmissions. This is illustrated in FIG. 12 showing a schematic diagram illustrating a fourth embodiment of an Ack policy according to the present disclosure.

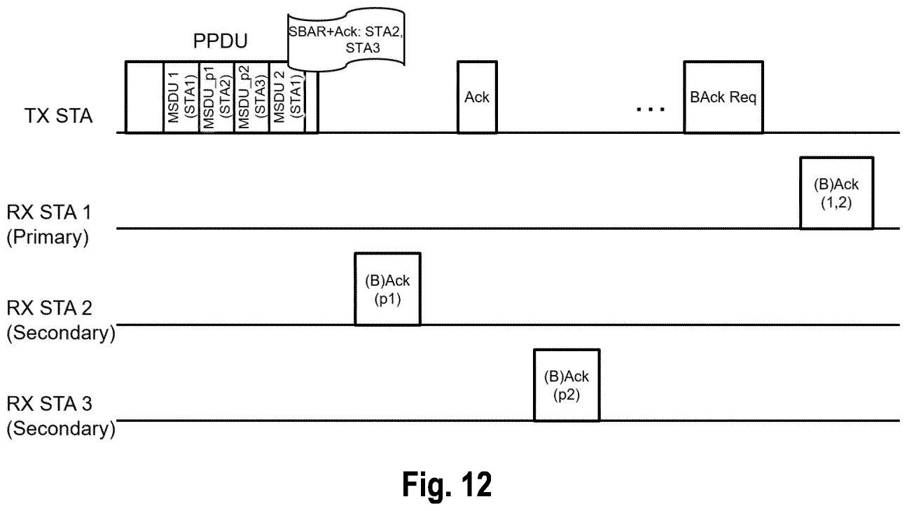

Next, a preemption use case of the present disclosure will be described. This refers to the case when a high priority MPDU (addressed to a different STA), referred to as preemptive MPDU, is inserted in the A-MPDU after the PHYTXSTART.request. This is illustrated in FIG. 13 showing a schematic diagram of another embodiment of the present disclosure relating to the insertion of a high priority MPDU 12 in an A-MPDU 10 after PPDUTXSTART.request. In this case, the preemptive MPDU 12 replaces one or more MPDUs 11 scheduled for transmission (in this case the last MPDU 11′), which will be sent in later PPDUs. Thus, the following considerations should be taken by the transmitter STA.

The multi-STA A-MPDU length should not exceed the PSDU length indicated in PHYTXSTART.request at the start of the PPDU transmission. This can be achieved by one or more of the following: The length of the preemptive MPDU shall be the same as the length of the non-preemptive MPDU being replaced, and/or fragmentation and padding shall respect the PSDU length.

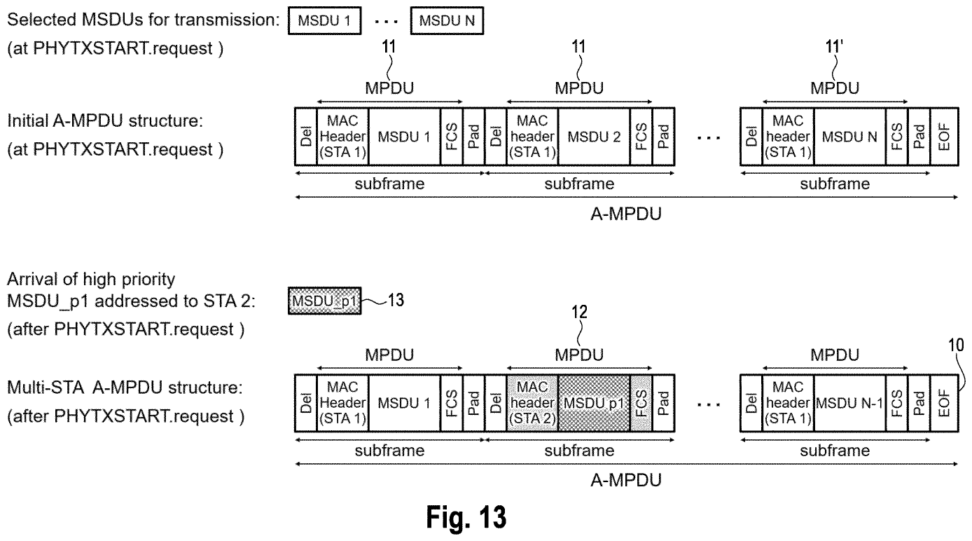

FIG. 14 shows a schematic diagram of an embodiment of insertion of a preemptive MPDU in a multi-STA A-MPDU according to the present disclosure using fragmentation. In this case MSDU 2 is divided into two parts wherein the first part has enough octets to fill the remainder of the A-MPDU length without exceeding the PSDU length. The second part would be transmitted in a later PPDU (not shown).

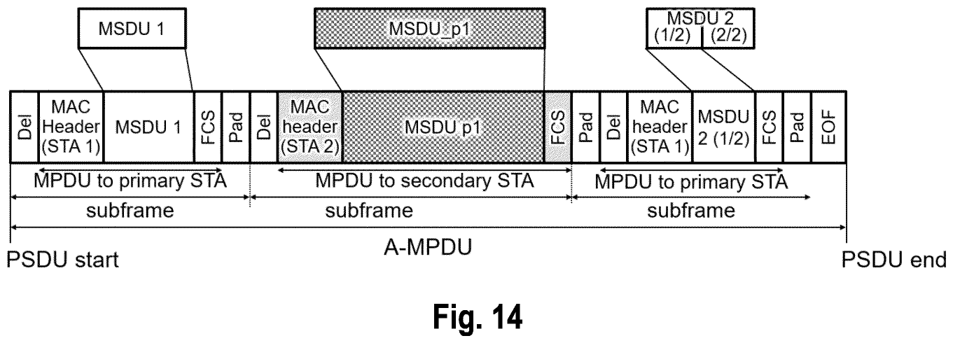

FIG. 15 shows schematic diagrams of embodiments of insertion of a preemptive MPDU in a multi-STA A-MPDU according to the present disclosure using padding. According to a first embodiment shown in FIG. 15A delimiters (DEL) 16 with length zero are used to pad the end of the A-MPDU. This option can be used when the padding length, i.e., the difference between the end of the last A-MPDU subframe and the end of the PSDU, is small or below a predefined margin. According to a second embodiment shown in FIG. 15B several MSDUs 17 are aggregated into an A-MSDU 18 to create a MPDU that can fill the remainder of the A-MPDU length. This option can be used when the padding length is large or above a margin. However, it requires the following considerations: The RA of the aggregated MSDUs in the A-MSDU should be the same, the MSDUs used for padding should have the same or higher priority as the preemptive MSDU, and fragmentation of additional MSDUs can be done to obtain an MPDU length that fulfills the A-MPDU length.

The duration field of the preemptive MPDU should be the same as the one in all MPDUs within the A-MPDU. That is, it should provide a consistent indication to the end of the PPDU (the same as all other MPDUs in the A-MPDU) such that other STAs can set their network allocation vector (NAV) properly.

To support multi-STA A-MPDU operation with legacy STAs, they can be considered as primary STAs, wherein the following considerations may be taken into account. The general transmitter STA operation with primary receiver STA as legacy STA may be modified as follows: It can transmit a multi-STA A-MPDU to a primary STA that is a legacy STA with which no multi-STA A-MPDU session was set up. It shall use an implicit multi-STA A-MPDU indication, meaning, the PPDU format and A-MPDU format shall be legacy com-patible. Only MPDUs addressed to the primary STA shall be included before the MPDUs addressed to secondary STAs. Special DEL or subframe shall be inserted after the MPDUs addressed to the primary STAs have been transmitted that is not legacy compatible. The DEL or subframe causes the primary STA to not be able to decode the rest of the A-MPDU, and the DEL or subframe also indicates to a secondary STA that the following MPDUs are addressed to it.

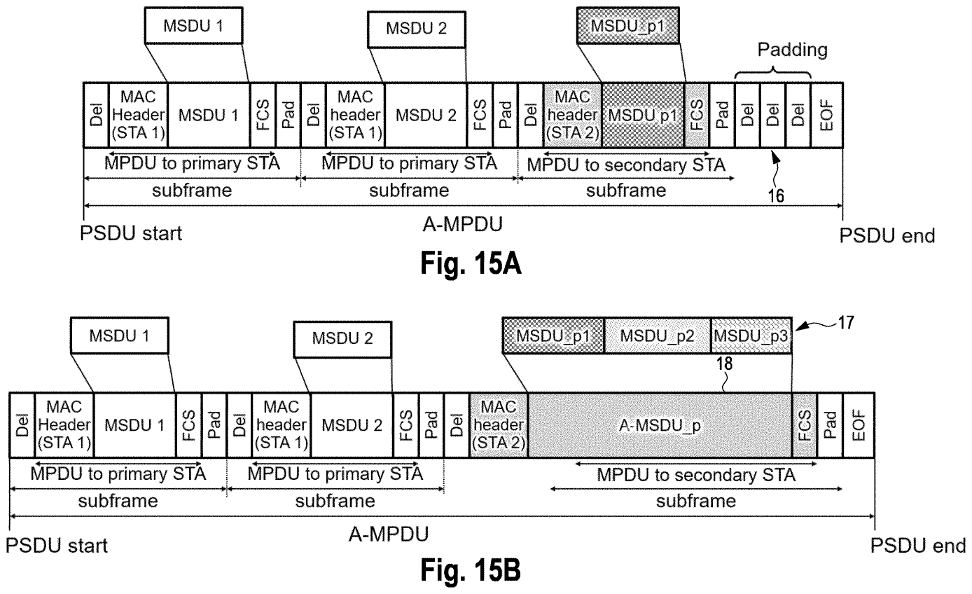

FIG. 16 shows a flowchart of an embodiment of a transmission method 100 according to the present disclosure as performed by a transmission device. In a first step 101, input data units to be transmitted to one or more receiving devices are obtained (received or retrieved, e.g. from a higher layer) and/or generated. The input data units comprise MSDUs and/or control data units. In a second step 102, MPDUs are generated from said input data units by adding header information to one or more of said input data units. The header information includes at least the receiver address of said one or more input data units. In a third step 103 one or more A-MPDUs are generated from said MPDUs. An A-MPDU is generated from at least two of said MPDUs. Into at least one A-MPDU MPDUs addressed to different receiving devices identified by the receiver address in the header of each MPDU are included. In a fourth step 104 PPDUs are generated from said A-MPDUs. In a fifth step 105 in said PPDUs and/or said A-MPDUs a multi-receiver indication is provided implicitly or explicitly. Said multi-receiver indication indicates if an A-MPDU includes MPDUs addressed to different receiving devices. In a sixth step 106 said PPDUs are transmitted, wherein the PPDU containing said at least one A-MPDU is transmitted to different receiving devices.

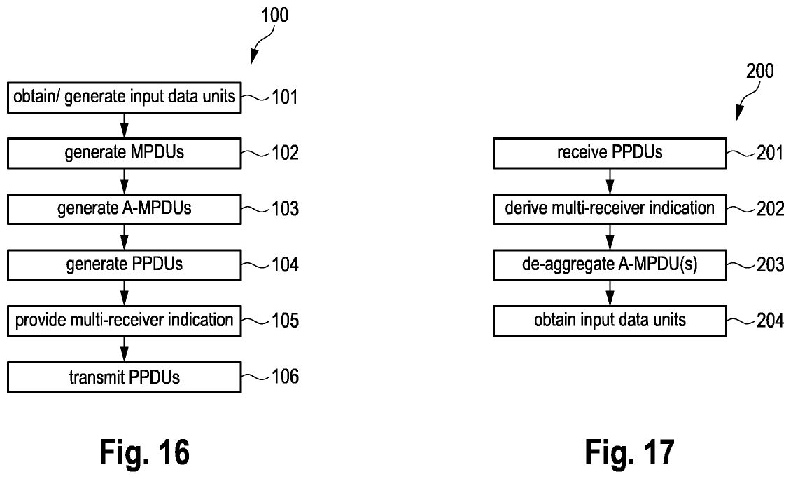

FIG. 17 shows a flowchart of an embodiment of a receiving method 200 according to the present disclosure as performed by a receiving device that is able to process multi-STA A-MPDUs.

In a first step 201 PPDUs are received from a transmission device. In a second step 202, from a received PPDU or an A-MPDU included in a received PPDU, a multi-receiver indication is derived, that explicitly or implicitly indicates if an A-MPDU included in the received PPDU includes MPDUs addressed to different receiving devices. In a third step 203, at least one A-MPDU for which a multi-receiver indication indicates that it includes MPDUs addressed to different receiving devices is de-aggregated and a receiver address is extracted from a header of the MPDUs. In a fourth step 204, one or more input data units are obtained from MPDUs addressed to the receiving device based on said receiver address, said input data units comprising MSDUs and/or control data units.

In summary, according to the present disclosure changes are made to the MAC operation of WLAN to support the transmission of A-MPDUs containing MPDUs that have different receiver stations (STA). This allows the insertion of preemptive MPDUs in the ongoing transmission of a PPDU carrying an A-MPDU. Further, this overcomes the limitation of the flexibility of the transmitter STA in the conventional WLAN operation if it has to deliver data to different STAs with different levels of priority.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriated circuits. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

It follows a list of further embodiments of the disclosed subject matter:
1. Transmission device comprising circuitry configured to:
   obtain and/or generate input data units to be transmitted to one or more receiving devices, said input data units comprising MAC service data units (MSDUs) and/or control data units;
   generate MAC protocol data units (MPDUs) from said input data units by adding header information to one or more of said input data units, the header information including at least the receiver address of said one or more input data units;
   generate one or more aggregated MAC protocol data units (A-MPDUs) from said MPDUs, wherein an A-MPDU is generated from at least two of said MPDUs and wherein into at least one A-MPDU MPDUs addressed to different receiving devices identified by the receiver address in the header of each MPDU are included;
   generate physical layer protocol data units (PPDUs) from said A-MPDUs;
   provide in said PPDUs and/or said A-MPDUs a multi-receiver indication implicitly or explicitly indicating if an A-MPDU includes MPDUs addressed to different receiving devices; and
   transmit said PPDUs, wherein the PPDU containing said at least one A-MPDU is transmitted to different receiving devices.
2. Transmission device according to embodiment 1,
wherein the circuitry is configured to include into said at least one A-MPDU one or more preemptive secondary MPDUs addressed to a secondary receiving device in addition to one or more primary MPDUs addressed to a primary receiving device even if the input data units included into the one or more preemptive secondary MPDUs are obtained or generated later than the input data units included into the primary MPDUs addressed to the primary receiving device and/or after a request to start transmission of the PPDU.
3. Transmission device according to embodiment 2,
wherein the circuitry is configured to include PPDU duration information indicating the PPDU duration into the PPDU containing said at least one A-MPDU.
4. Transmission device according to embodiment 2 or 3,
wherein the circuitry is configured to replace one or more primary MPDUs scheduled to be transmitted in said at least one A-MPDU by the one or more preemptive secondary MPDUs and to include the replaced one or more primary MPDUs into a PPDU to be transmitted later.
5. Transmission device according to embodiment 3,
wherein the circuitry is configured to maintain the PPDU duration indicated by the PPDU duration information in the request to start transmission by one of more of the following:
   aggregate or fragment one or more input data units included into primary MPDUs;
   aggregate one or more input data units included into secondary MPDUs; and
   insert padding bits into said A-MPDU.
6. Transmission device according to any one of the preceding embodiments,
wherein the circuitry is configured to include, as one or more initial MPDUs in said A-MPDU, one or more primary MPDUs addressed to a primary receiving device and to include one or more secondary MPDUs into said A-MPDU after said one or more initial MPDUs.
7. Transmission device according to embodiment 6,
wherein the circuitry is configured to obtain a transmit opportunity (TXOP) with at least the primary receiving device.
8. Transmission device according to any one of the preceding embodiments,
wherein the circuitry is configured to implicitly signal, as a multi-receiver indication, a receiver address as part of a MAC header of each MPDU within an A-MPDU, said receiver address uniquely identifying the receiving device of the MPDU associated with the MAC header.
9. Transmission device according to any one of the preceding embodiments,
wherein the circuitry is configured to include, into the PPDU containing said at least one A-MPDU and/or into said at least one A-MPDU and/or into each MPDU of said at least one A-MPDU, a secondary MPDU indication indicating that said PPDU includes one or more MPDUs addressed to a secondary receiving device different from a primary receiving device to which other MPDUs included into said PPDU are addressed and/or which MPDUs are addressed to the secondary receiving device.
10. Transmission device according to embodiment 9,
wherein the circuitry is configured to include the secondary MPDU indication into one or more of
   a header and/or a signaling field of said PPDU,
   a header of a MPDU of said at least one A-MPDU,
   a signaling field of said at least one A-MPDU,
   a delimiter field of said a signaling field of said at least one A-MPDU,
   a header of a first MPDU included in said at least one A-MPDU, and
   a separate indication field or frame.
11. Transmission device according to any one of the preceding embodiments,
wherein the circuitry is configured to explicitly indicate that said at least one A-MPDU includes MPDUs addressed to different receiving devices by including the multi-receiver indication into one or more of
   a header and/or a signaling field of said PPDU,
   a header of a MPDU of said at least one A-MPDU,
   a signaling field of said at least one A-MPDU,
   a delimiter field of said a signaling field of said at least one A-MPDU,
   a header of a first MPDU included in said at least one A-MPDU, and
   a separate indication field or frame.
12. Transmission device according to any one of the preceding embodiments,
wherein the circuitry is configured to implicitly indicate that said at least one A-MPDU includes MPDUs addressed to different receiving devices by including at least one MPDU addressed to a primary receiver as the first MPDU in said at least one A-MPDU.
13. Transmission device according to any one of the preceding embodiments,
wherein the circuitry is configured to include the receiver address at least into a header of MPDUs addressed to a secondary receiving device different from a primary receiving device or into a header of all MPDUs.)
14. Transmission device according to any one of the preceding embodiments,
wherein the circuitry is configured to set an acknowledgment policy indicating how the receiving devices shall acknowledge receipt of one or more MSDUs included into an MPDU of said at least one A-MPDU and to include an acknowledgement policy indication indicating the set acknowledgement policy into each header of the MPDUs of said at least one A-MPDU.
15. Transmission device according to embodiment 14,
wherein the circuitry is configured to set, as part of the set acknowledgement policy,
   if and which receiving device shall acknowledge receipt of an MSDU immediately,
wherein at a time only a single receiving device shall acknowledge receipt, and/or
   if receipt of an MSDU shall be acknowledged in response to an acknowledgement request or without an acknowledgement request, and/or
   if receipt of an MSDU shall not be acknowledged at all or shall be acknowledge with delay.
16. Transmission device according to any one of the preceding embodiments,
wherein the circuitry is configured to aggregate or fragment one or more primary MSDUs addressed to a primary receiving device and/or to aggregate one or more secondary MSDUs addressed to a secondary receiving device and/or to add padding bits into said A-MPDU.
17. Transmission device according to any one of the preceding embodiments,
wherein the circuitry is configured to initially perform a session setup with one or more receiving devices
   to agree if a multi-receiver operation may be used in which an A-MPDU may include MPDUs addressed to different receiving devices, and/or
   to define a primary receiving device and one or more secondary receiving devices in the multi-receiver operation, and/or
   to exchange capabilities and parameters to be used in the multi-receiver operation.
18. Transmission device according to any one of the preceding embodiments,
wherein the circuitry is configured to use parameters for PHY layer processing that are supported by multiple or all receiving devices to which MPDUs may be addressed in said at least one A-MPDU and/or based on the link quality of receiving devices to which MPDUs may be addressed in said at least one A-MPDU.
19. Receiving device comprising circuitry configured to:
   receive physical layer protocol data units (PPDUs) from a transmission device;
   derive, from a received PPDU or an aggregated MAC protocol data unit (A-MPDU) included in a received PPDU, a multi-receiver indication explicitly or implicitly indicating if an A-MPDU included in the received PPDU includes MAC protocol data units (MPDUs) addressed to different receiving devices; and
   de-aggregate at least one A-MPDU for which a multi-receiver indication indicates that it includes MPDUs addressed to different receiving devices and to extract a receiver address from a header of the MPDUs; and
   obtain one or more input data units from MPDUs addressed to the receiving device based on said receiver address, said input data units comprising MAC service data units (MSDUs) and/or control data units.
20. Receiving device according to claim 19,
wherein the circuitry is configured to
   derive, from said PPDU and/or said at least one A-MPDU, a secondary MPDU indication indicating that said at least one A-MPDU includes one or more MPDUs addressed to the receiving device different from a primary receiving device to which at least the first MPDU included into said at least one A-MPDU is addressed and/or which MPDUs are addressed to the receiving device; and
   obtain one or more MPDUs addressed to the receiving device based on the secondary MPDU indication.
21. Receiving device according to claim 19 or 20,
wherein the circuitry is configured to derive the multi-receiver indication and/or the secondary MPDU indication from one or more of
   a header and/or a signaling field of said PPDU,
   a header of a MPDU of said at least one A-MPDU
   a signaling field of said at least one A-MPDU,
   a delimiter field of said a signaling field of said at least one A-MPDU,
   a header of a first MPDU included in said at least one A-MPDU,
   a separate indication field or frame, and
   a header of a first MPDU addressed to a primary receiver.
22. Receiving device according to any one of embodiments 19 to 21,
wherein the circuitry is configured to derive, from each MPDU in said at least one A-MPDU in a received PPDU, an acknowledgement policy indication indicating an acknowledgement policy set by the transmission device, the acknowledgement policy indicating how the receiving device shall acknowledge receipt of one or more MSDUs included into an MPDU of said at least one A-MPDU, and to acknowledge receipt of MSDUs according to said acknowledgement policy.
23. Receiving device according to embodiment 22,
wherein the circuitry is configured, based on the indicated acknowledgement policy, to
   transmit an acknowledgement of the receipt of an MSDU immediately, and/or
   transmit an acknowledgement of the receipt of an MSDU in response to an acknowledgement request or without an acknowledgement request, and/or
   not transmit or transmit an acknowledgement of the receipt of an MSDU with delay.
24. Receiving device according to any one of embodiments 19 to 23,
wherein the circuitry is configured to participate in a session setup with a transmission device
   to agree if a multi-receiver operation may be used in which an A-MPDU may include MPDUs addressed to different receiving devices, and/or
   to define the receiving device as a primary receiving device and/or a secondary receiving device in the multi-receiver operation, and/or
   to exchange capabilities and parameters to be used in the multi-receiver operation.
25. Transmission method comprising:
   obtaining and/or generating input data units to be transmitted to one or more receiving devices, said input data units comprising MAC service data units (MSDUs) and/or control data units;
   generating MAC protocol data units (MPDUs) from said input data units by adding header information to one or more of said input data units, the header information including at least the receiver address of said one or more input data units;
   generating one or more aggregated MAC protocol data units (A-MPDUs) from said MPDUs, wherein an A-MPDU is generated from at least two of said MPDUs and wherein into at least one A-MPDU MPDUs addressed to different receiving devices identified by the receiver address in the header of each MPDU are included;
   generating physical layer protocol data units (PPDUs) from said A-MPDUs;
   providing in said PPDUs and/or said A-MPDUs a multi-receiver indication implicitly or explicitly indicating if an A-MPDU includes MPDUs addressed to different receiving devices; and
   transmitting said PPDUs, wherein the PPDU containing said at least one A-MPDU is transmitted to different receiving devices.
26. Receiving method comprising:
   receiving physical layer protocol data units (PPDUs) from a transmission device;
   deriving, from a received PPDU or an aggregated MAC protocol data unit (A-MPDU) included in a received PPDU, a multi-receiver indication explicitly or implicitly indicating if an A-MPDU included in the received PPDU includes MAC protocol data units (MPDUs) addressed to different receiving devices; and
   de-aggregating at least one A-MPDU for which a multi-receiver indication indicates that it includes MPDUs addressed to different receiving devices and to extract a receiver address from a header of the MPDUs; and
   obtaining one or more input data units from MPDUs addressed to the receiving device based on said receiver address, said input data units comprising MAC service data units (MSDUs) and/or control data units.
27. A non-transitory computer-readable recording medium that stores therein a computer program product, which, when executed by a processor, causes the method according to embodiment 25 or 26 to be performed.
28. A computer program comprising program code means for causing a computer to perform the steps of said method according to embodiment 25 or 26 when said computer program is carried out on a computer.

1. Transmission device comprising circuitry configured to:
obtain and/or generate input data units to be transmitted to one or more receiving devices, said input data units comprising MAC service data units (MSDUs) and/or control data units;
generate MAC protocol data units (MPDUs) from said input data units by adding header information to one or more of said input data units, the header information including at least the receiver address of said one or more input data units;
generate one or more aggregated MAC protocol data units (A-MPDUs) from said MPDUs, wherein an A-MPDU is generated from at least two of said MPDUs and wherein into at least one A-MPDU MPDUs addressed to different receiving devices identified by the receiver address in the header of each MPDU are included;
generate physical layer protocol data units (PPDUs) from said A-MPDUs;
provide in said PPDUs and/or said A-MPDUs a multi-receiver indication implicitly or explicitly indicating if an A-MPDU includes MPDUs addressed to different receiving devices; and
transmit said PPDUs, wherein the PPDU containing said at least one A-MPDU is transmitted to different receiving devices.

2. Transmission device according to claim 1,
wherein the circuitry is configured to include into said at least one A-MPDU one or more preemptive secondary MPDUs addressed to a secondary receiving device in addition to one or more primary MPDUs addressed to a primary receiving device even if the input data units included into the one or more preemptive secondary MPDUs are obtained or generated later than the input data units included into the primary MPDUs addressed to the primary receiving device and/or after a request to start transmission of the PPDU.

3. Transmission device according to claim 2,
wherein the circuitry is configured to replace one or more primary MPDUs scheduled to be transmitted in said at least one A-MPDU by the one or more preemptive secondary MPDUs and to include the replaced one or more primary MPDUs into a PPDU to be transmitted later.

4. Transmission device according to claim 1,
wherein the circuitry is configured to include PPDU duration information indicating the PPDU duration into the PPDU containing said at least one A-MPDU and/or to maintain the PPDU duration indicated by the PPDU duration information in the request to start transmission by one of more of the following:
aggregate or fragment one or more input data units included into primary MPDUs;
aggregate one or more input data units included into secondary MPDUs; and
insert padding bits into said A-MPDU.

5. Transmission device according to claim 1,
wherein the circuitry is configured to include, as one or more initial MPDUs in said A-MPDU, one or more primary MPDUs addressed to a primary receiving device and to include one or more secondary MPDUs into said A-MPDU after said one or more initial MPDUs.

6. Transmission device according to claim 5,
wherein the circuitry is configured to obtain a transmit opportunity (TXOP) with at least the primary receiving device.

7. Transmission device according to claim 1,
wherein the circuitry is configured to implicitly signal, as a multi-receiver indication, a receiver address as part of a MAC header of each MPDU within an A-MPDU, said receiver address uniquely identifying the receiving device of the MPDU associated with the MAC header.

8. Transmission device according to claim 1,
wherein the circuitry is configured to include, into the PPDU containing said at least one A-MPDU and/or into said at least one A-MPDU and/or into each MPDU of said at least one A-MPDU, a secondary MPDU indication indicating that said PPDU includes one or more MPDUs addressed to a secondary receiving device different from a primary receiving device to which other MPDUs included into said PPDU are addressed and/or which MPDUs are addressed to the secondary receiving device, in particular to include the secondary MPDU indication into one or more of
a header and/or a signaling field of said PPDU,
a header of a MPDU of said at least one A-MPDU,
a signaling field of said at least one A-MPDU,
a delimiter field of said a signaling field of said at least one A-MPDU,
a header of a first MPDU included in said at least one A-MPDU, and
a separate indication field or frame.

9. Transmission device according to claim 1,
wherein the circuitry is configured to explicitly indicate that said at least one A-MPDU includes MPDUs addressed to different receiving devices by including the multi-receiver indication into one or more of
a header and/or a signaling field of said PPDU,
a header of a MPDU of said at least one A-MPDU,
a signaling field of said at least one A-MPDU,
a delimiter field of said a signaling field of said at least one A-MPDU,
a header of a first MPDU included in said at least one A-MPDU, and
a separate indication field or frame.

10. Transmission device according to claim 1,
wherein the circuitry is configured to implicitly indicate that said at least one A-MPDU includes MPDUs addressed to different receiving devices by including at least one MPDU addressed to a primary receiver as the first MPDU in said at least one A-MPDU.

11. Transmission device according to claim 1,
wherein the circuitry is configured to set an acknowledgment policy indicating how the receiving devices shall acknowledge receipt of one or more MSDUs included into an MPDU of said at least one A-MPDU and to include an acknowledgement policy indication indicating the set acknowledgement policy into each header of the MPDUs of said at least one A-MPDU, in particular to set, as part of the set acknowledgement policy,
if and which receiving device shall acknowledge receipt of an MSDU immediately, wherein at a time only a single receiving device shall acknowledge receipt, and/or
if receipt of an MSDU shall be acknowledged in response to an acknowledgement request or without an acknowledgement request, and/or
if receipt of an MSDU shall not be acknowledged at all or shall be acknowledge with delay.

12. Transmission device according to claim 1,
wherein the circuitry is configured to aggregate or fragment one or more primary MSDUs addressed to a primary receiving device and/or to aggregate one or more secondary MSDUs addressed to a secondary receiving device and/or to add padding bits into said A-MPDU.

13. Transmission device according to claim 1,
wherein the circuitry is configured to initially perform a session setup with one or more receiving devices
to agree if a multi-receiver operation may be used in which an A-MPDU may include MPDUs addressed to different receiving devices, and/or
to define a primary receiving device and one or more secondary receiving devices in the multi-receiver operation, and/or
to exchange capabilities and parameters to be used in the multi-receiver operation.

14. Transmission device according to claim 1,
wherein the circuitry is configured to use parameters for PHY layer processing that are supported by multiple or all receiving devices to which MPDUs may be addressed in said at least one A-MPDU and/or based on the link quality of receiving devices to which MPDUs may be addressed in said at least one A-MPDU.

15. Receiving device comprising circuitry configured to:
receive physical layer protocol data units (PPDUs) from a transmission device;
derive, from a received PPDU or an aggregated MAC protocol data unit (A-MPDU) included in a received PPDU, a multi-receiver indication explicitly or implicitly indicating if an A-MPDU included in the received PPDU includes MAC protocol data units (MPDUs) addressed to different receiving devices; and
de-aggregate at least one A-MPDU for which a multi-receiver indication indicates that it includes MPDUs addressed to different receiving devices and to extract a receiver address from a header of the MPDUs; and
obtain one or more input data units from MPDUs addressed to the receiving device based on said receiver address, said input data units comprising MAC service data units (MSDUs) and/or control data units.

16. Receiving device according to claim 15,
wherein the circuitry is configured to
derive, from said PPDU and/or said at least one A-MPDU, a secondary MPDU indication indicating that said at least one A-MPDU includes one or more MPDUs addressed to the receiving device different from a primary receiving device to which at least the first MPDU included into said at least one A-MPDU is addressed and/or which MPDUs are addressed to the receiving device; and
obtain one or more MPDUs addressed to the receiving device based on the secondary MPDU indication.

17. Receiving device according to claim 15,
wherein the circuitry is configured to participate in a session setup with a transmission device
to agree if a multi-receiver operation may be used in which an A-MPDU may include MPDUs addressed to different receiving devices, and/or
to define the receiving device as a primary receiving device and/or a secondary receiving device in the multi-receiver operation, and/or
to exchange capabilities and parameters to be used in the multi-receiver operation.

18. Transmission method comprising:
obtaining and/or generating input data units to be transmitted to one or more receiving devices, said input data units comprising MAC service data units (MSDUs) and/or control data units;
generating MAC protocol data units (MPDUs) from said input data units by adding header information to one or more of said input data units, the header information including at least the receiver address of said one or more input data units;
generating one or more aggregated MAC protocol data units (A-MPDUs) from said MPDUs, wherein an A-MPDU is generated from at least two of said MPDUs and wherein into at least one A-MPDU MPDUs addressed to different receiving devices identified by the receiver address in the header of each MPDU are included;
generating physical layer protocol data units (PPDUs) from said A-MPDUs;
providing in said PPDUs and/or said A-MPDUs a multi-receiver indication implicitly or explicitly indicating if an A-MPDU includes MPDUs addressed to different receiving devices; and
transmitting said PPDUs, wherein the PPDU containing said at least one A-MPDU is transmitted to different receiving devices.

19. Receiving method comprising:
receiving physical layer protocol data units (PPDUs) from a transmission device;
deriving, from a received PPDU or an aggregated MAC protocol data unit (A-MPDU) included in a received PPDU, a multi-receiver indication explicitly or implicitly indicating if an A-MPDU included in the received PPDU includes MAC protocol data units (MPDUs) addressed to different receiving devices; and
de-aggregating at least one A-MPDU for which a multi-receiver indication indicates that it includes MPDUs addressed to different receiving devices and to extract a receiver address from a header of the MPDUs; and
obtaining one or more input data units from MPDUs addressed to the receiving device based on said receiver address, said input data units comprising MAC service data units (MSDUs) and/or control data units.

20. A non-transitory computer-readable recording medium that stores therein a computer program product, which, when executed by a processor, causes the method according to claim 18 or 19 to be performed.
